(19) United States
(12) Patent Application Publication
(10) Pub. No.: US 2014/0109902 A1
(43) Pub. Date: Apr. 24, 2014

(54) Respirator-Attachable Lamp Unit

(71) Applicants: Mike Lane, Huntington Beach, CA (US); G. Albert Hreish, Riverside, CA (US); Peter Abrahamson, Burbank, CA (US); Eric Abrahamson, Encinitas, CA (US)

(72) Inventors: Mike Lane, Huntington Beach, CA (US); G. Albert Hreish, Riverside, CA (US); Peter Abrahamson, Burbank, CA (US); Eric Abrahamson, Encinitas, CA (US)

(21) Appl. No.: 13/659,385

(22) Filed: Oct. 24, 2012

(51) Int. Cl. F21V 5/04; F21L 4/00; F21L 4/02; A62B 18/08

(52) U.S. Cl. 128/201.19; 362/311.01; 362/157; 362/184

(57) ABSTRACT

A Respirator-Attachable Lamp Unit. The lamp unit is attachable to a conventional respirator mask or gas mask without obstructing the mask or modifying its operation. The lamp unit, once installed, provides the user with a hands-free light source. The lamp unit may be formed in a horseshoe-shaped housing having a translucent front lens surrounding the speech module of the mask. An external power source may be provided for extended use situations. A user is able to select from a variety of wavelengths for the light emitted from the lamp unit. LED light elements are one type of light source employed by the lamp unit.

### BACKGROUND OF THE INVENTION

1. Field of the Invention

This invention relates generally to respirators and other breathing apparatus and, more specifically, to a Respirator-Attachable Lamp Unit.

2. Description of Related Art

With the proliferation, or suspected proliferation of chemical and biological weapons, gasmasks, respirators and supplied-air breathing apparatus has become a critical component in the modern soldier's equipment. An example of one of many conventional respirator mask assemblies, or “gas masks” is depicted in FIG. 1.

FIG. 1 is a front view of a prior art respirator mask assembly¹ 10. The mask assembly 10 has a mask base 12 made from pliable, chemically-resistant material. The base 12 supports all of the other features of the assembly 10, and is designed to completely cover the wearer's face to prevent airborne (and even a certain amount of liquid) chemical contaminants from reaching the wearer's face. ¹ Avon™ FM53 “Special Forces” respirator

A (typically clear) view window is provided to allow the wearer to see out through the assembly 10. One or more filter sockets 16 are formed into the mask base 12 to allow for replaceable filter cartridges 18 or other breathing source adapters to be installed on the mask assembly 10. The empty socket 16 shown here is actually a pass-through barrier to allow the wearer to insert a radio microphone or the like through the mask 12 and to the vicinity of the wearer's mouth. When the wearer breathes, air will be drawn in through the filter(s) 18, so that chemical contaminants that are removed by the particular type of filter cartridge 18 will be removed prior to inhalation by the wearer.

As with most gas masks, the depicted version has a speech module² 22. A speech module 22 is a battery-powered unit that provides amplification to the wearer's voice when speaking from within the mask assembly 10. ² Avon™ “Voice Projection Unit” depicted.

One significant drawback to conventional respirator mask assemblies is that, in addition to the mask 10 covering the entire face, the wearer is also completely encased in chemical-resistant clothing, including hands and feet. This makes handling tools, weapons and equipment very challenging and unwieldy. As such, any tools or the like that could be integrated into the clothing or respirator mask assembly 10 would be very helpful. One particular gap in the prior respirator accessories is a light source. While small clip-on task lights have been available, these devices are more like reading lights than they are battle equipment. Having a heavy duty, readily-accessible lighting unit attached to the respirator mask assembly 10 would be extremely helpful in improving the wearer's vision in low light conditions, while also eliminating one more tool for the wearer to have to operate with his or her hands.

### SUMMARY OF THE INVENTION

In light of the aforementioned problems associated with the prior devices and accessories, it is an object of the present invention to provide a Respirator-Attachable Lamp Unit. The lamp unit should be attachable to a conventional respirator mask or gas mask without obstructing the mask or modifying its operation. The lamp unit, once installed, should provide the user with a hands-free light source. The lamp unit may be formed in a horseshoe-shaped housing having a translucent front lens surrounding the speech module of the mask. An external power source may be provided for extended use situations. A user should be able to select from a variety of wavelengths for the light emitted from the lamp unit. LED light elements should be one type of light source employed by the lamp unit.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a front view of a prior art respirator;

FIG. 2 is a front view of the respirator of FIG. 1 having a preferred embodiment of the respirator-attachable lamp unit installed thereon;

FIG. 3 is a side view of the combination of FIG. 2;

FIG. 4 is an exploded perspective view of the lamp unit of FIGS. 2 and 3;

FIG. 5 is a front view of the lamp unit of FIGS. 2-4, along with an optional power supply; and

FIG. 6 is a back view of the lamp unit of FIGS. 2-5.

### DETAILED DESCRIPTION OF THE PREFERRED EMBODIMENTS

The following description is provided to enable any person skilled in the art to make and use the invention and sets forth the best modes contemplated by the inventors of carrying out their invention. Various modifications, however, will remain readily apparent to those skilled in the art, since the generic principles of the present invention have been defined herein specifically to provide a Respirator-Attachable Lamp Unit.

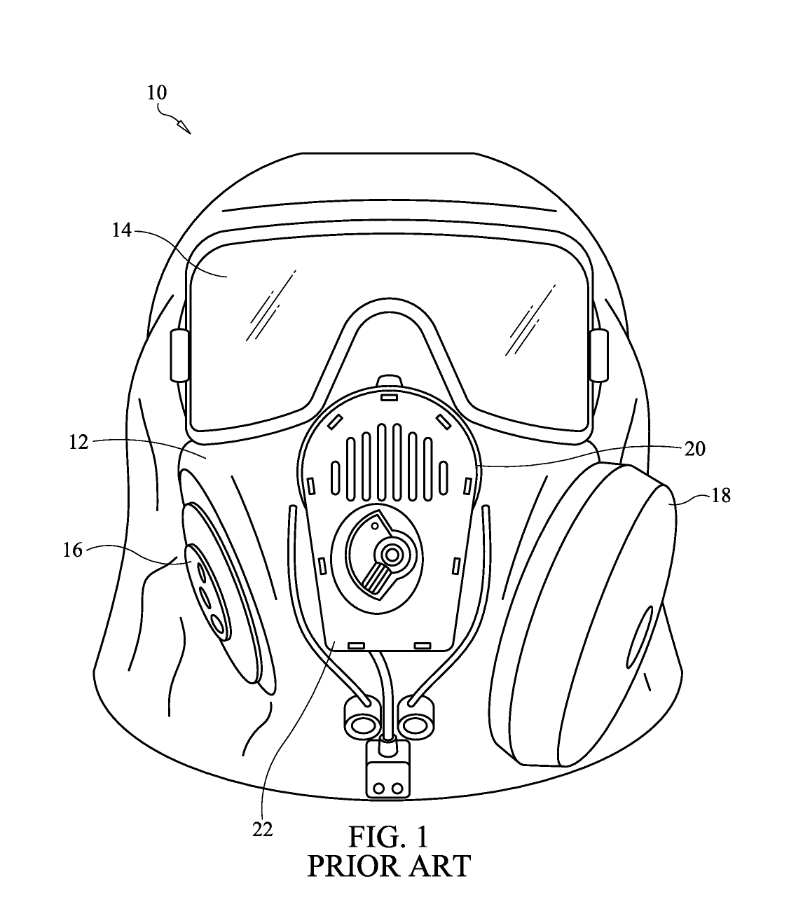

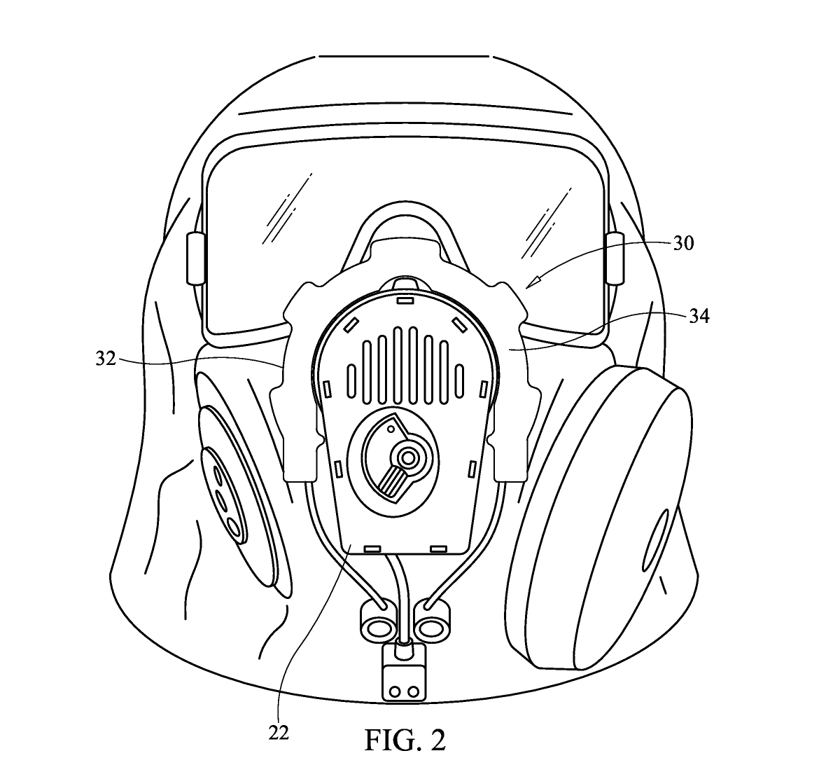

The present invention can best be understood by initial consideration of FIG. 2. FIG. 2 is a front view of the respirator 10 of FIG. 1 having a preferred embodiment of the respirator-attachable lamp unit 30 installed thereon. The lamp unit 30 is designed to operate with a variety of different mask assemblies. In this particular drawing, the Avon™ model FM53 of FIG. 1 is being used; however, the unit 30 can be configured in a variety of forms to fit virtually any respirator mask assembly 10 readily on the market today.

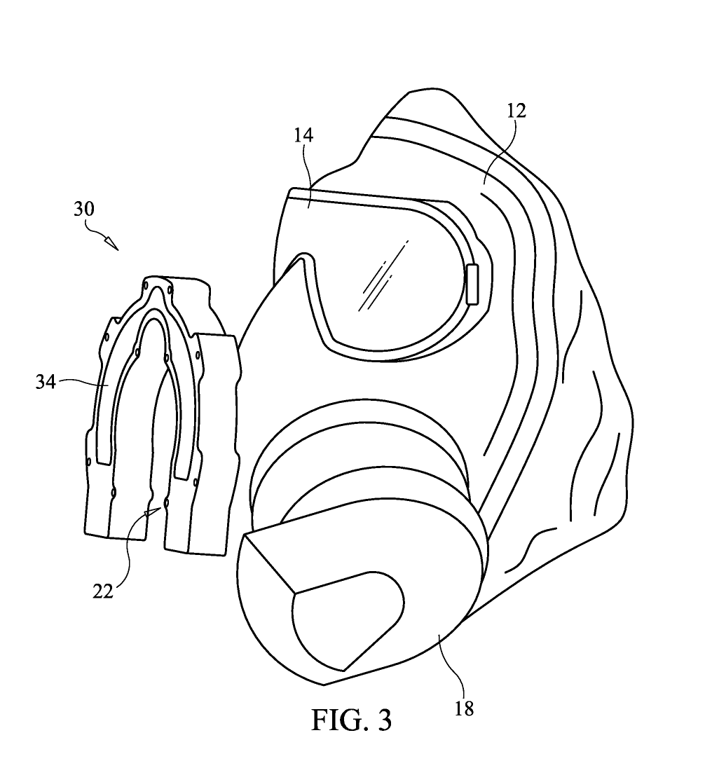

The respirator-attachable lamp unit 30 is designed to cooperate with a speech module 22 so that it fits above the speech module 22 yet below the viewing window. The unit 30 is defined in part by an outer housing 32 which is designed in the horseshoe shape as shown here that is further comprised of a semitransparent diffuser lens 34 which serves to create a solid light panel from the plurality of individual lighting elements found within the housing 32. If we now turn to FIG. 3, we can examine the assembly in further detail.

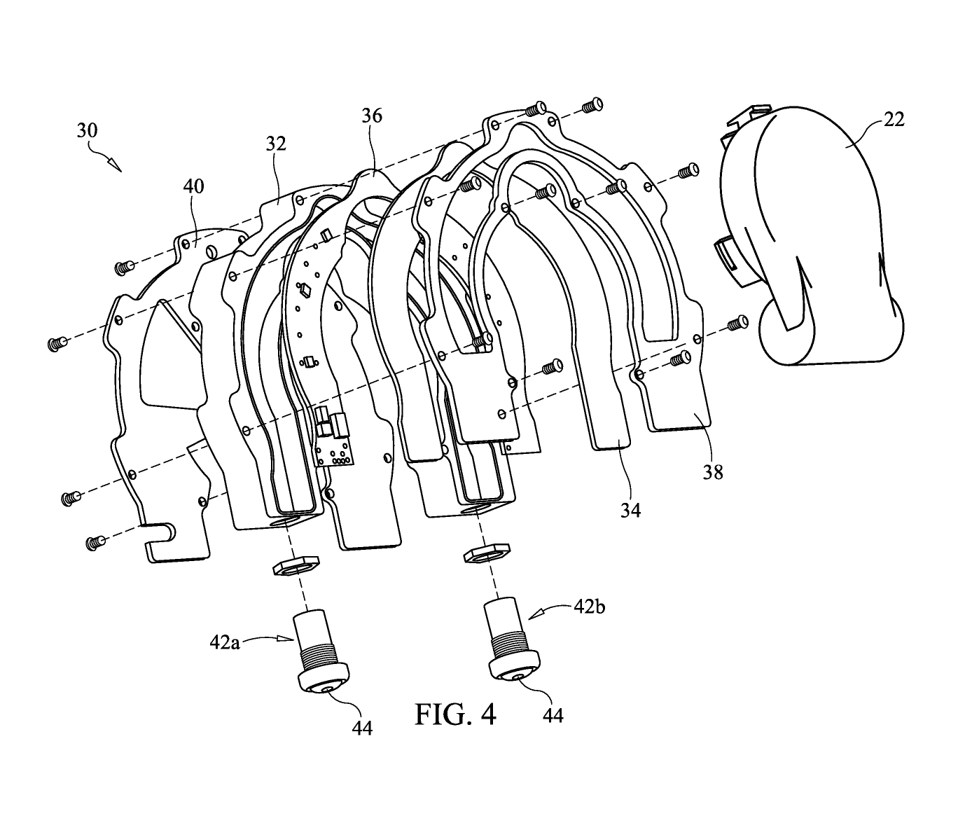

FIG. 3 is a side view of the combination of FIG. 2. As can be seen, the respirator-attachable lamp unit 30 is arranged so that it fits against the mask base 12 below the view window 14. It is held in place by the speech module 22 and is kept clear of the filter cartridge 18. As can further be appreciated by this drawing figure, the user, when wearing the respirator 10 can easily see out the view window 14 and around the unit 30 in order to see clearly with the improved light being provided by the lamp 30. This is particularly critical for low-light conditions which are common where circumstances require the use of the respirator assembly. FIG. 4 picks the individual elements making up the unit of the present invention.

FIG. 4 is an exploded perspective view of the lamp unit of FIGS. 2 and 3. As seen, the housing 32 is a hollow horseshoe-shaped container that is covered on its front side by the front cover 38 and on its rear side by the rear cover 40. A lamp module 36 is located within the housing 32 and contains a plurality of both white LEDs as well as infrared emitters. The unit 30 is designed so that the user can either use the white lighting provided by the white LEDs or the infrared lighting provided by the infrared LEDs. It would not be normal to use both at one time. The unit 30 may be provided with a status indicator such as a red light that is viewable by the wearer to alert the wearer that the infrared lighting is activated.

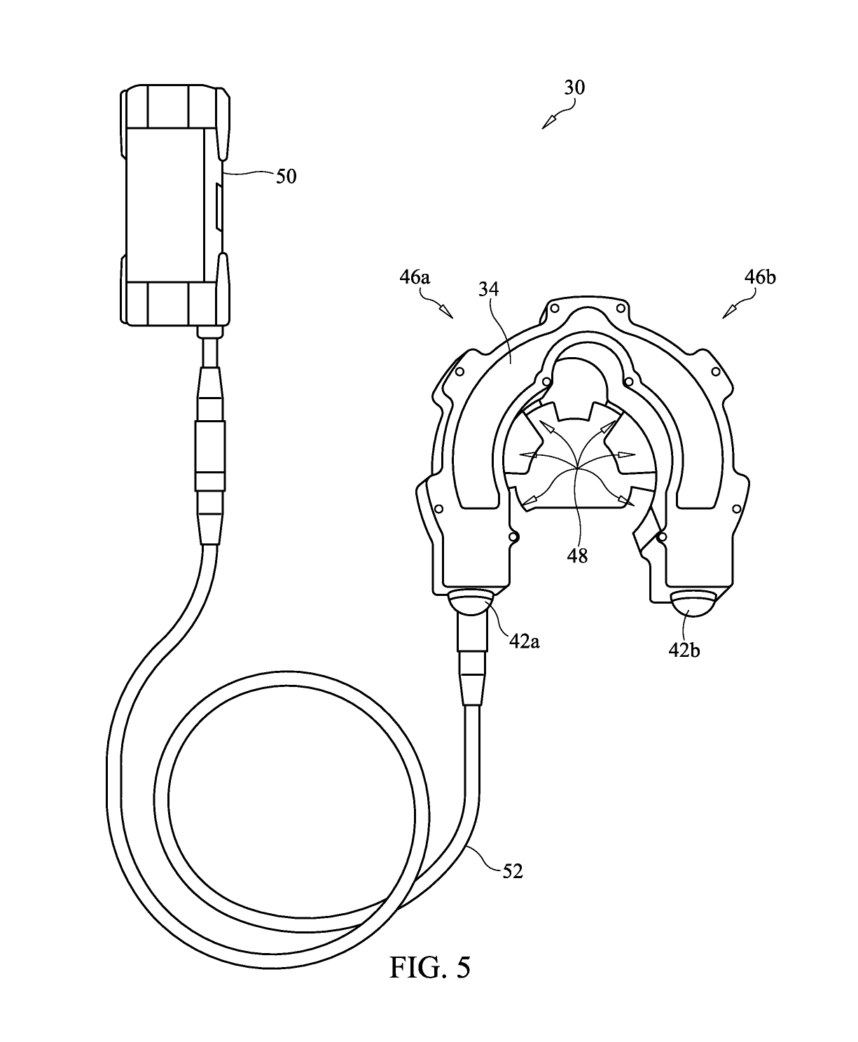

As discussed previously, the lamp module 36 lies behind the diffuser lens 34. The diffuser lens is held to the face of the housing 32 by the front cover 38. On the two ends of the horseshoe-shaped housing 32 are located a pair of power switch cap assemblies 42A and 42B. These power switch cap assemblies each have a button 44 which when pressed will activate and deactivate either the white or the infrared lightning. As can be seen here, the open area in the center of the covers 38 and 40 and the housing 32 are designed to fit around the outer periphery of the speech module 22. FIG. 5 shows the unit in its entirety.

FIG. 5 is a front view of the lamp unit 30 of FIGS. 2-4, along with an optional power supply. The unit 30 may have internal batteries within the housing 32, or it may be provided with an auxiliary battery pack 50 in order to provide additional lighting duration. The battery pack 50 would typically include rechargeable replaceable batteries so that the wearer of the gas mask and light unit 30 can either recharge or replace the power source very quickly.

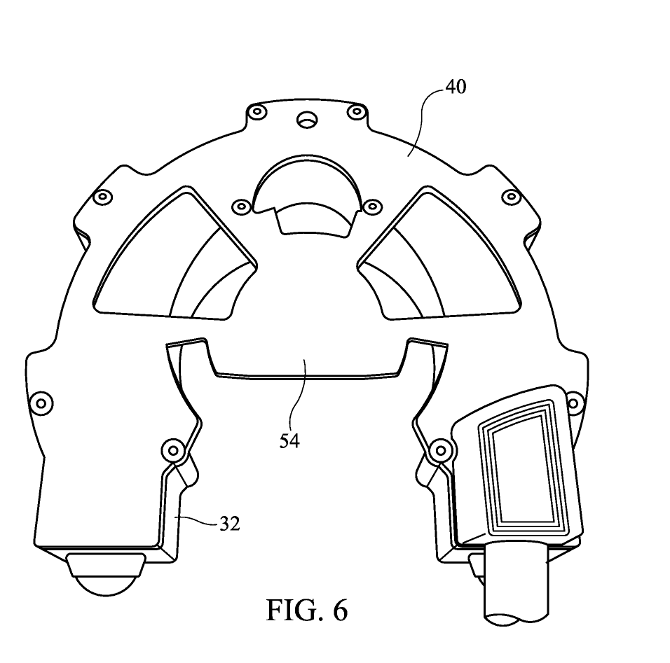

The unit 30 as discussed previously defines a horseshoe shape having a first arm 46A and a second arm 46B. The two arms 46A, 46B partially surround a central bore 48. The speech unit will fit within the central bore 48. A power cable interconnects the battery pack 50 and the housing 32. As can be shown, there is a disconnect along the cable 52 so that the battery pack 50 can be replaced as discussed previously. If we finally turn to FIG. 6, we can discuss the final details of the present design.

FIG. 6 is a back view of the lamp unit 30 of FIGS. 2-5. The rear cover 40 is designed with a retaining web 54 interconnecting the first and second arms of the housing. The retaining web 54 is designed to be captured between the speech unit and the mask base so that the unit 30 is securely captured and retained against the gas mask. Furthermore, there are a plurality of holes between the individual elements of the retaining web 54 to allow for sound emanating from the wearer's mouth to reach the speech unit. Because of this retaining web design, the unit 30 can be attached and detached very simply without the need for additional structural changes to the gas mask.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A lamp device, comprising:
a horseshoe-shaped housing defined by a wall surrounding the horseshoe-shaped perimeter of said housing, said housing having an open front side opposing an open back side;
a translucent lens covering said open front side;
a rear cover covering said open back side; and
light-producing means located within the interior chamber defined by said housing, said lens and said rear cover.

2. The device of claim 1, wherein:
said housing, said lens and said rear cover each define an outer periphery in substantial relative alignment; and
said rear cover further defines a retaining web extending across a central bore defined by said housing.

3. The device of claim 2, wherein said horseshoe shape comprises an arcuate first arm extending from an arcuate second arm, said arms meeting at a central arch.

4. The device of claim 3, wherein said wall of said housing further comprises an inner wall defining said central bore and an outer wall defining said outer periphery, and said inner wall further comprises a second arcuate section at said central arch.

5. The device of claim 4, further comprising a battery pack and power cable connected to said housing.

6. The device of claim 5, wherein said light-producing means comprises a lamp module housed within said interior chamber, said lamp module comprising:
a substrate member;
one or more light-producing elements attached to said substrate member cooperatively with said lens whereby light emitted by said one or more light-producing elements is viewable through said lens; and
an electrical connection between said power cable.

7. The device of claim 6, wherein at least one said light-producing element emits light in a wavelength visually perceptible to the human senses, and at least one said light-producing element emits light in a wavelength that is not visually perceptible to the human senses.

8. A combination face mask and lamp device, comprising:
a face mask, comprising:
a mask base configured to seal to the front of a human face;
a view window formed to seal an aperture formed in said mask base;
a speech bore formed through said mask base oriented to be juxtaposed over a human mouth when said mask base is worn on a human face; and
a speech module attachable to said speech bore;
a lamp device, comprising:
a housing defining a central bore, said central bore formed such that said speech bore can protrude therethrough;
a translucent lens forming an outer wall of said housing; and
light-emitting means contained within said housing, behind said lens; and
whereby said lamp device is attachable to said face mask by removing said speech module, placing said central bore of said housing over said speech bore and then reattaching said speech module to said speech bore.

9. The combination of claim 8, wherein said lamp device further comprises:
said housing comprising a horseshoe-shaped housing defined by a wall surrounding the horseshoe-shaped perimeter of said housing, said housing having an open front side opposing an open back side;
said translucent lens covering said open front side;
a rear cover covering said open back side; and
light-producing means located within the interior chamber defined by said housing, said lens and said rear cover.

10. The combination of claim 9, wherein said light-producing means comprises a lamp module housed within said interior chamber, said lamp module comprising:
a substrate member; and
one or more light-producing elements attached to said substrate member cooperatively with said lens whereby light emitted by said one or more light-producing elements is viewable through said lens.

11. The combination of claim 10 wherein at least one said light-producing element emits light in a wavelength visually perceptible to the human senses, and at least one said light-producing element emits light in a wavelength that is not visually perceptible to the human senses.

12. An attachment for a gasmask, the gasmask defined by a mask base configured to seal to the front of a human face, a view window formed to seal an aperture formed in said mask base, a speech bore formed through said mask base oriented to be juxtaposed over a human mouth when said mask base is worn on a human face, a speech module attachable to said speech bore, said attachment comprising:
a housing defining a central bore, said central bore formed such that said speech bore can protrude therethrough when said attachment is attached to said gasmask;
a translucent lens forming an outer wall of said housing; and
light-emitting means contained within said housing, behind said lens.

13. The attachment of claim 12, wherein said housing and lens each comprise a first arm and a second arm said arms defining a generally arcuate shape around said central bore.

14. The attachment of claim 13, further comprising a first power switch disposed on a distal end defined by said first arm.

15. The attachment of claim 14, further comprising a second power switch disposed on a distal end defined by said second arm.

16. The attachment of claim 15, wherein:
said housing comprises a horseshoe-shaped housing defined by a wall surrounding the horseshoe-shaped perimeter of said housing, said housing having an open front side opposing an open back side;
said translucent lens covering said open front side; and
a rear cover covering said open back side.

17. The attachment of claim 16, wherein said light-emitting means selectively emits light in a wavelength visually perceptible to the human senses, and further selectively emits light in a wavelength that is not visually perceptible to the human senses.
